(19) United States
(12) Patent Application Publication
(10) Pub. No.: US 2013/0267644 A1
(43) Pub. Date: Oct. 10, 2013

(54) ACRYLATE RUBBER RAW MATERIAL COMPOSITION FOR CRANKCASE VENTILATION HOSE

(71) Applicant: Lei Zhang, Zhucheng (CN)

(72) Inventor: Lei Zhang, Zhucheng (CN)

(21) Appl. No.: 13/637,252

(22) PCT Filed: Feb. 10, 2011
(86) PCT No.: PCT/CN2011/070920

§ 371 Date: Sep. 25, 2012

(30) Foreign Application Priority Data
Oct. 28, 2010 (CN) 201010608531.0

(51) Int. Cl. C08L 13/00

(52) U.S. Cl. CPC C08L 13/00
USPC 524/523

(57) ABSTRACT

The present invention makes public a type of acrylate rubber materials used in crankcase ventilation pipes, which belongs to the technological field of rubber and has the following characteristic qualities: acrylate rubber PA 402L, 40-70; acrylate rubber PA 402H, 30-60; stearic acid, 1-2; age resister Dusantox 86, 2-3; processing agent Vanfre VAM, 1-2; carbon black N330, 25-45; carbon black N550, 10-30; potassium stearate, 0.2-0.5; sodium stearate, 1-4; brimstone, 0.1-0.3. The oil resistance of this acrylate rubber made by the above mentioned materials is superior than the now commonly used acrylate rubber's, its heat resistance corresponds to ethylene acrylate rubber's and its cost is cheaper.

### BACKGROUND OF THE INVENTION

1. Field of the Invention

The present invention belongs to the technical field of rubber, particularly involved is an acrylate rubber raw material composition for crankcase ventilation hose.

2. Description of the Related Art

The under part of the cylinder block of the automobile engine is used to install the part of crank axle called crank case. The car crank case divides superior and inferior crank case. Superior crack case casts into a whole with the cylinder block, the inferior one is to keep lubricating oil in storage and to close the superior crack case. When the engine is running, in the burning chamber the high pressure burning gases, acids, moistures, sulfur and nitric oxide enter into the crank case in the gap between a piston ring and a casing wall, and lump with the metal powder produced by elements abrade, forming greasy filth. After a little while they are suspended in the filth, after a long time they are separated from the filth, block the filth and the oil hole, cause difficulties to the engine lubrication, rouse attrition. Today most part of gasoline engines are equipped with forced ventilation device for the crank case, through the air-pipe the crank case gases return into the engine, where they continue burning. These so called car crank case gases precipitate into condensation and harm the rubber materials of car crank case ventilation pipe. Under different driving conditions of the engine, the condensed elements have great differences. The vast majority is constituted by the following three parts: fuel, engine oil and some liquid acidic materials (pH 2-6). The corrosion of the car crank case ventilation pipe due to these mediums and the ageing of the rubber materials due to the heat diffused by the engine have a great influence on the performance and the life span of the car crank case ventilation pipe.

As the car crank case gases include non-burning fuel gas, engine oil mist, acid, sulfur and nitric oxide etc, this requires that the car crank case ventilation pipe has excellent fuel oil, durable engine oil and resistance to corrosion; at the same time, as the car crank case ventilation pipe is around the engine, this also requires that it has a very good heat-resistant quality. At the moment, many car crank case ventilation pipes use acrylate rubber, but this acrylate rubber already hardly bears the increasingly high temperature of the car crank case gases. There are also some motorcycles using ethylene acrylate rubber, but the oil resistance properties of ethylene acrylate rubber are worse than the ones of acrylate rubber, and it is more expensive, thus it is hardly diffused in common cars.

### SUMMARY OF THE INVENTION

The purpose of the present invention is to provide an oil resistance performance that is superior to today's common acrylate rubber, heat resistance capacity and ethylene acrylate rubber, and also acrylate rubber raw materials whose cost is cheaper.

To gather the above mentioned purposes, the present invention provides a type of acrylate rubber materials used in crankcase ventilation pipes, it has to have the following qualities and characteristics: acrylate rubber PA 402L, 40-70; acrylate rubber PA 402H, 30-60; stearic acid, 1-2; age resister Dusantox 86, 2-3; processing agent Vanfre VAM, 1-2; carbon black N330, 25-45; carbon black N550, 10-30; potassium stearate, 0.2-0.5; sodium stearate, 1-4; sulfur, 0.1-0.3.

Acrylate rubber (ACM) is the main monomer of alkyl acrylate (CH2═CH—COOR), with a small quantity it can provide monomer copolymerization of an active group of cross-linking reaction and an elastomer. According to the different crosslinking monomers of its molecular structure, the in-process vulcanization system is also different, therefore the acrylate rubber is divided into a type containing chlorine and amine crosslinking, a type not containing chlorine and amine crosslinking, a self crosslinking type, a carboxylic acid and ammonium salt crosslinking type, a soap crosslinking type and other five types. In addition, there are some special acrylate rubbers, for instance the type containing fluorine and the thermoplastic acrylate rubber. Acrylate rubber has very good thermostability and oily properties, but that does not imply that it can be immediately used, in fact one aspect to be researched is selecting appropriate marks and vulcanization system and reinforce system.

The present invention chooses the acrylate rubber PA-402L and PA-402H of Japanese NOK joint-stock company, whose molecular structure has two common features: the first is a high polarity; the second is a complete saturation, consequently a superior mineral oil and high temperature oxidation susceptibility. Its oil resistivity ranks only second to fluorine rubber and is similar to normal-high acrylonitrile content nitrile rubber. Its heat resistance is between common rubber and silicon rubber, it is 30-60° C. higher than the operating temperature of nitrile rubber, the highest operating temperature is 180%, in short-time and discontinuous use it can reach 200° C., in long-term functional performance at 150° C. there is not any evident change. In addition, the most important thing is that its pressure lubricating oil containing sulfur, chlorine and phosphorous extreme pressure agent is very steady, the operating temperature can reach 150° C., if interrupted the operating temperature can be even a little higher. Acrylate rubber has also anti-ozone properties, tightness leak, bearing scratch and split growing properties, ultraviolet-resistant chromism etc, can be used under the high temperature of the engine surroundings, and the variations of its performance are small. Then, due to the difference of Mooney viscosity (PA-402L has a low Mooney, PA-402H has a high Mooney), in the using time of both of them, low Mooney has processing advantages and high Mooney has performing advantages. This guarantees very good working properties and physical and mechanical properties at the same time.

Potassium stearate, sodium stearate, sulfur constitute a soap vulcanization system. The vulcanization speed of sodium stearate is slow and the process is secure, potassium stearate is easy burning. Using potassium stearate and sodium stearate, the percentage of use is changed, it is possible to control burning time, and the influence on vulcanization condition is not notable. Sulfur can enhance vulcanization speed and degree. Through a reasonable matching, these three factors can guarantee sizing vulcanization speed and processing security.

Car crank case ventilation pipe acts as an extrusion system, therefore sizing materials are required to have very good squeezing properties. The present invention uses fast squeezing carbon black N550 to guarantee sizing squeezing properties, at the same time it uses high wear-resisting furnace black N330 to guarantee the strength of vulcanized rubber.

### DETAILED DESCRIPTION OF THE PREFERRED EMBODIMENTS

### Example 1

| No. | Component | Quantity/part |
|---|---|---|
| 1 | Acrylate rubber PA 402L | 45 |
| 2 | Acrylate rubber PA 402H | 55 |
| 3 | Stearic acid | 1.2 |
| 4 | Age resister Dusantox 86 | 2.5 |
| 5 | Processing agent Vanfre VAM | 1.6 |
| 6 | Carbon black N330 | 30 |
| 7 | Carbon black N550 | 25 |
| 8 | Potassium stearate | 0.3 |
| 9 | Sodium stearate | 3 |
| 10 | Sulfur | 0.2 |

Preparation materials of example 1 have the following car crank case gas properties:

According to the test method⁽¹⁾, after 6 cycle times the material properties are as follows:

| No. | Item | Technical requirements | Experimental results |
|---|---|---|---|
| 1 | Aspect | No cementation | No cementation |
| | | phenomena, no flaws | phenomena, no |
| | | | flaws |
| 2 | Changes of | Maximum change 20%, | Hardness |
| | materials | hardness at least 55 | change −10%, |
| | hardness | shore A | hardness 63 |
| | | | shore A |
| 3 | Changes of | Maximum change 40%, | Tensile strength |
| | materials tensile | tensile strength at least | change −22%, |
| | strength | greater than 6 MPa | tensile strength 11.4 |
| | | | MPa |
| 4 | Changes of | Maximum change 65%, | Snap elongation rate |
| | material snap | snap elongation rate at | change −34%, snap |
| | elongation rate | least greater than 80% | elongation rate |
| | | | 264% |
| 5 | Changes of | Maximum increase 20% | Increase 5% |
| | materials weight | | |

### Example 2

| No. | Component | Quantity/part |
|---|---|---|
| 1 | Acrylate rubber PA 402L | 65 |
| 2 | Acrylate rubber PA 402H | 35 |
| 3 | Stearic acid | 1.7 |
| 4 | Age resister Dusantox 86 | 2.8 |
| 5 | Processing agent Vanfre VAM | 2 |
| 6 | Carbon black N330 | 25 |
| 7 | Carbon black N550 | 30 |
| 8 | Potassium stearate | 0.4 |
| 9 | Sodium stearate | 3.5 |
| 10 | Sulfur | 0.3 |

Preparation materials of example 2 have the following car crank case gas properties:

According to the test method⁽¹⁾, after 6 cycle times the material properties are as follows:

| No. | Item | Technical requirements | Experimental results |
|---|---|---|---|
| 1 | Aspect | No cementation | No cementation |
| | | phenomena, no flaws | phenomena, no |
| | | | flaws |
| 2 | Changes of | Maximum change 20%, | Hardness |
| | materials | hardness at least 55 | change −8%, |
| | hardness | shore A | hardness 64 |
| | | | shore A |
| 3 | Changes of | Maximum change 40%, | Tensile strength |
| | materials tensile | tensile strength at least | change −19%, |
| | strength | greater than 6 MPa | tensile strength 11.8 |
| | | | MPa |
| 4 | Changes of | Maximum change 65%, | Snap elongation rate |
| | material snap | snap elongation rate at | change −28%, snap |
| | elongation rate | least greater than 80% | elongation rate |
| | | | 288% |
| 5 | Changes of | Maximum increase 20% | Increase 6% |
| | materials weight | | |

### Example 3

| No. | Component | Quantity/part |
|---|---|---|
| 1 | Acrylate rubber PA 402L | 55 |
| 2 | Acrylate rubber PA 402H | 45 |
| 3 | Stearic acid | 1.5 |
| 4 | Age resister Dusantox 86 | 2.6 |
| 5 | Processing agent Vanfre VAM | 1.8 |
| 6 | Carbon black N330 | 40 |
| 7 | Carbon black N550 | 15 |
| 8 | Potassium stearate | 0.3 |
| 9 | Sodium stearate | 3.5 |
| 10 | Sulfur | 0.25 |

Preparation materials of example 3 have the following car crank case gas properties:

According to the test method⁽¹⁾, after 6 cycle times the material properties are as follows:

| No. | Item | Technical requirements | Experimental results |
|---|---|---|---|
| 1 | Aspect | No cementation | No cementation |
| | | phenomena, no flaws | phenomena, no |
| | | | flaws |
| 2 | Changes of | Maximum change 20%, | Hardness |
| | materials | hardness at least 55 | change −12%, |
| | hardness | shore A | hardness 62 |
| | | | shore A |
| 3 | Changes of | Maximum change 40%, | Tensile strength |
| | materials tensile | tensile strength at least | change −17%, |
| | strength | greater than 6 MPa | tensile strength 12.1 |
| | | | MPa |
| 4 | Changes of | Maximum change 65%, | Snap elongation rate |
| | material snap | snap elongation rate at | change −41%, snap |
| | elongation rate | least greater than 80% | elongation rate |
| | | | 236% |
| 5 | Changes of | Maximum increase 20% | Increase 8% |
| | materials weight | | |

Remarks (1) Test Method

The test sample requires to be placed in a plugged 200m1 polished glass, pour 100 ml of PH 5 nitric acid and then put it in the mechanical ventilation heating box and maintain for 4 hours at less than 60° C. Then use distilled water to wash the sample, continue drying the remaining liquids, and dry for 30 minutes at room temperature.

Then put the sample in a 250 ml glass beaker (deep type) covered with a sheet glass (for example watch glass) and keep it in Lubrizol engine oil OS 304 206 at 135° C. for 18 hours. When the action time is over, use detection fluid to wash the components (filamentary paper) and keep below room temperature for 30 minutes. Keep it below room temperature in detection liquid FAM-B for 30 minutes, after completing the fuel storage air dry the components below room temperature for 15 minutes.

The above explained cycle has to be repeated according to the need, then the sample's functional test is completed and that marks periodicity.

What is claimed is:

1. An acrylate rubber raw material composition for crankcase ventilation hose comprising the following characteristic qualities: acrylate rubber PA 402L, 40-70; acrylate rubber PA 402H, 30-60; stearic acid, 1-2; age resister Dusantox 86, 2-3; processing agent Vanfre VAM, 1-2; carbon black N330, 25-45; carbon black N550, 10-30; potassium stearate, 0.2-0.5; sodium stearate, 1-4; brimstone, 0.1-0.3.

2. The acrylate rubber raw material composition for crankcase ventilation systems according to claim 1, comprising the following characteristic qualities: acrylate rubber PA 402L, 45; acrylate rubber PA 402H, 55; stearic acid, 1.2; age resister Dusantox 86, 2.5; processing agent Vanfre VAM, 1.6; carbon black N330, 30; carbon black N550, 25; potassium stearate, 0.3; sodium stearate, 3; brimstone, 0.2.

3. The acrylate rubber raw material composition for crankcase ventilation systems according to claim 1, comprising the following characteristic qualities: acrylate rubber PA 402L, 65; acrylate rubber PA 402H, 35; stearic acid, 1.7; age resister Dusantox 86, 2.8; processing agent Vanfre VAM, 2; carbon black N330, 25; carbon black N550, 30; potassium stearate, 0.4; sodium stearate, 3.5; brimstone, 0.3.

4. The acrylate rubber raw material composition for crankcase ventilation systems according to claim 1, comprising the following characteristic qualities: acrylate rubber PA 402L, 55; acrylate rubber PA 402H, 45; stearic acid, 1.5; age resister Dusantox 86, 2.6; processing agent Vanfre VAM, 1.8; carbon black N330, 40; carbon black N550, 15; potassium stearate, 0.3; sodium stearate, 3.5; brimstone, 0.25.
